(19) United States
(12) Patent Application Publication
(10) Pub. No.: US 2021/0132379 A1
(43) Pub. Date: May 6, 2021

(54) DISPLAY DEVICE AND METHOD FOR PROJECTING DISPLAY INFORMATION IN A VEHICLE

(71) Applicant: Vision Technics UG (Haftungsbeschraenkt), Dresden (DE)

(72) Inventor: Ronald DITTRICH, Dresden (DE)

(21) Appl. No.: 16/491,871

(22) PCT Filed: Mar. 2, 2018
(86) PCT No.: PCT/EP2018/055137

§ 371 Date: Sep. 6, 2019

(30) Foreign Application Priority Data
Mar. 8, 2017 (DE) 10 2017 002 229.1

(51) Int. Cl. G02B 27/01; B60K 37/04

(52) U.S. Cl. CPC G02B 27/0103; B60K 37/04; B60K 2370/31; B60K 2370/1529; B60K 2370/779; B60K 2370/29

(57) ABSTRACT

A display apparatus (10) configured to project display information in the field of view of a user (1) of a vehicle (80) with a dashboard (81) and a front window (82), comprising an imaging device (20) adapted to generate a light field (2) carrying the display information, a hologram device (30), which, in an arrangement below the field of view (4) of the user (1), is adapted for deflecting the light field (2) to the front window (82) and for generating a virtual image (3) of the display information in the field of view (4) of the user (1), and a control device (40) for controlling the imaging device (20), said hologram device (30) being configured for generating said virtual image (3) when said imaging device (20) is disposed above of the hologram device (30) and on a side of the hologram device (30) facing the field of view (4) of the user (1). A method for projecting display information in the field of view of a user (1) of a vehicle (80) is also described.

The invention relates to a display apparatus (head-up display) for a vehicle, in particular a display apparatus for projecting display information in the field of view of a user of the vehicle by employing a hologram device. Furthermore, the invention relates to a method for projecting display information in the field of view of a user of a vehicle and a vehicle provided with the display apparatus. Applications of the invention are given in particular in vehicle technology, e.g. in motor vehicles for the transport of persons and/or loads or rail vehicles or aircraft or water vehicles.

Head-up displays for displaying information in the driver's field of view in motor vehicles are generally known. Conventional head-up displays typically comprise an imaging device in the form of a projector and imaging optics. The projector creates a light field that carries the information to be presented. With the imaging optics, the light field is projected into the driver's field of view in such a way that a virtual image is generated on the side of the vehicle's windscreen facing away from the driver, enabling the driver to read the information without fatigue.

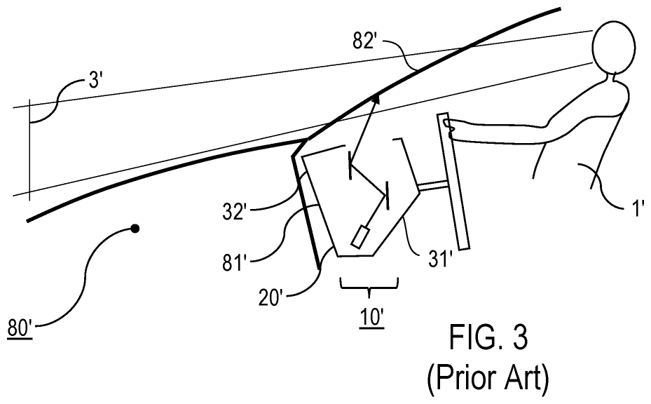

The imaging optics can be constructed with optical lenses and mirrors, but this has disadvantages due to the high costs (formation of free-form optics), the space required and the weight of the imaging optics. It was therefore proposed to replace optical lenses and mirrors with holograms, as described e. g. in EP 286 962 A2 and shown in FIG. 3 (prior art). According to FIG. 3, the conventional head-up display 10′ includes a projector 20′ and holograms 31′, 32′, which are arranged in the dashboard 81′ of the vehicle 80′ above the projector 20′. With the holograms 31′, 32′ the light field of the projector 20′ is displayed as a virtual image 3′ of the display information on the side of the front window 82′ facing away from the driver 1′.

The holograms 31′, 32′ reduce the disadvantages of conventional imaging optics with optical lenses and mirrors, since the holograms 31′, 32′ can be designed as short focal length optics with low weight and space requirements. However, a disadvantage is that the holograms 31′, 32′ have to be configured depending on the geometric conditions in the vehicle 80′, e.g. the curvature of the windscreen 82′. This means that for each vehicle type a separate configuration of a head-up display 10′ with specific characteristics adapted to the vehicle type is required, which has a negative effect on the costs of conventional head-up displays. Another problem is that space in the dashboard is usually limited, so even when holograms are used it is a design challenge to integrate the head-up display into the dashboard. In addition, there is only limited access to the head-up display in the dashboard, so that it is hardly possible to make readjustments, for example to adjust it to the driver's head height.

From DE 100 36 570 A1 a display apparatus for a vehicle is known which comprises a projection unit above the driver and a display surface for displaying or generating a real image generated by the projection unit. The display surface may have a reflective microstructure e.g. with prisms or saw-tooth shapes for directional light deflection. The microstructure can have a negative effect on the image quality.

Another general problem of hologram-based head-up displays is their temperature sensitivity. For example, the temperature in a motor vehicle can vary over a wide range, e.g. up to 80 degrees. However, the diffraction properties of holograms and thus the imaging properties of the imaging optics can change depending on the ambient temperature, so that extreme temperature fluctuations can lead to display disturbances. In addition, the holograms require the use of laser projectors, where a drift of emission wavelengths can occur as a function of the operating temperature.

These problems occur not only in head-up displays for motor vehicles, but also in other applications such as aircraft or ships.

The objective of the invention is to provide an improved display apparatus that avoids the disadvantages of conventional techniques. In particular, the display apparatus should have a simplified design, avoid restrictions on installation in a vehicle, allow retrofitting of vehicles and/or improve image quality, in particular independently of ambient and/or operating temperature and/or ambient light. Further objectives of the invention are to provide a correspondingly improved method for projecting display information in the field of view of the user of a vehicle and a vehicle provided with a display apparatus which avoid disadvantages of conventional techniques.

These objectives are solved by a display apparatus, a method for projecting display information in the field of view of a user of a vehicle and a vehicle with the features of the independent claims. Advantageous embodiments and applications of the invention result from the dependent claims.

According to a first general aspect of the invention, the above-mentioned objective is solved by a display apparatus configured to project display information in the field of view of a user of a vehicle with a dashboard and a transparent screen, e.g. front window. The display apparatus comprises an imaging device for generating a light field, a hologram device for deflecting the light field to the transparent screen and for generating a virtual image on the outside of the vehicle, and a control device for controlling the imaging device. The imaging device is controlled with the control device, so that the generated light field carries the information (display information) to be presented. The imaging device is configured to generate a monochromatic or multi-coloured light field. The hologram device includes at least one optical hologram configured for placement in an area below the field of view of the user, in particular below the transparent screen portion located in the direction of the user's view. In a vehicle, the hologram device is located below the windscreen. The field of view is the solid angle range into which the user's view is directed when the vehicle is in operation. Typically, the user is a driver (or a pilot or skipper). However, the display apparatus may also be configured for another person, such as a front passenger in a vehicle. The display apparatus is formed with the hologram device in such a way that a real intermediate image containing the display information is redirected to the transparent screen to generate the virtual image on the outside of the vehicle. Preferably, the hologram device comprises a smooth (geometrically unstructured) layer, particularly preferably of a plurality of sublayers, in which the optical hologram is formed by refractive index differences in the layer material (phase volume hologram). Advantageously, for this reason, a high image quality is achieved.

According to the invention, the hologram device is formed in such a way that the virtual image is generated when the imaging device is arranged on a side of the hologram device facing the user's field of view. The hologram device is formed such that when the imaging device is at a position according to an arrangement in the vehicle above the hologram device, the virtual image is generated in the field of view of the user. In a vehicle, the imaging device is arranged so that the light field is directed towards the hologram device from above. The imaging device is arranged above the hologram device, in particular above the planar extent of the at least one hologram.

The advantage of irradiating the holographic device from above is that it avoids many of the limitations of conventional display apparatuses, such as those shown in FIG. 3. This means that the display apparatus does not have to be installed inside the dashboard of the vehicle. The imaging device and the hologram device can be located outside the dashboard in a space saving manner. This simplifies the installation of the display apparatus in a vehicle or its retrofit with a display apparatus.

In accordance with a preferred embodiment of the invention, the hologram device is formed so that the virtual image is generated when the imaging device is arranged in a vehicle above the dashboard of the vehicle. Advantageously, in vehicles, especially in motor vehicles, there are various possibilities to arrange the imaging device outside the field of view of the user, e.g. in the area of the vehicle roof or e.g. the A-pillar. Particularly preferred is an embodiment of the invention wherein the imaging device is adapted for positioning on a rear-view mirror unit of the vehicle, in particular for integration into the rear-view mirror unit. The rear-view mirror unit is located in the inner space of the vehicle, typically in the middle above the dashboard. When the imaging device is positioned at the rear-view mirror unit, the light field is preferably directed towards the hologram device from an area above, and relative to the viewing direction in front of and laterally to the user's head. It is advantageous that there is sufficient space available at the rear-view mirror unit for the installation of the imaging device and, if necessary, an image height adjustment device.

According to another preferred embodiment of the invention, the imaging device is a projector device with a projector arranged to generate the light field and with an intermediate screen configured to generate a real intermediate image of the light field emitted by the projector device. The projector is preferably a laser projector. The intermediate screen may include, for example, a ground glass (diffuser screen) with an omnidirectional radiation characteristic. This variant offers advantages due to the simple construction and low costs of the diffuser screen. Alternatively, the intermediate screen can comprise a hologram, especially a transmission or reflection hologram, with directional radiation. In this case, the light from the real intermediate image is directed to the hologram device, which has an advantageous effect on the brightness of the image produced by the display apparatus and the utilization of the light field produced by the projector. For example, a projector with a relatively low light output can be used without affecting the brightness of the displayed virtual image. The diffuser screen or inter-screen hologram may be flat or curved. A curvature is chosen in such a way that any subsequent distortions of the light field that may occur by reflections at the hologram and the viewing screen are compensated for.

In accordance with an alternative embodiment of the invention, the imaging device comprises a liquid crystal screen arranged to generate the light field, with a narrow-band, monochromatic or multi-coloured backlight source. The liquid crystal display is arranged to display a real image representing the light field. The narrow band backlighting is chosen in such a way that the hologram device enables the directional, focused generation of the virtual image. The backlight source comprises, for example, a laser backlight source.

The hologram device preferably comprises a reflective holographic optical element (HOE) which forms a tilted off-axis concave mirror. In a HOE, the optical plane of the mirror function can advantageously differ from the physical hologram plane. In particular, at least one phase-volume hologram representing the off-axis mirror is provided. The inventor has found that a disadvantage of the conventional holograms of head-up displays is that they perform only a purely optical function and replace the respective mirror or lens components of conventional imaging optics. According to the invention, a single hologram device is sufficient for light deflection, which forms a concave mirror, e.g. a concave mirror with a paraboloid or ellipsoid shape. Advantageously, the phase-volume hologram can be configured solely depending on the shape of the light field of the projector device, the position of the imaging device and the position of the desired virtual image in the user's field of view and independent of the shape of the dashboard and front window. This allows the display apparatus to be designed independently of the vehicle type, which has an advantageous effect on its cost.

The hologram device may include a single broadband RGB hologram. In this case there are advantages for a simple construction of the hologram device. Alternatively, the hologram device may comprise a stack of several narrowband holograms, each designed for different wavelengths. With this variant there can be advantages for the image quality, especially the colour quality of the virtual image of the display information.

According to a further preferred embodiment of the invention, the hologram device is formed for an exposed arrangement on a surface of the dashboard of the vehicle. For example, the hologram device is attached directly to the surface of the dashboard or is provided with a support that is attached to the surface of the dashboard.

Advantageously, the hologram device may include at least one flat or curved hologram. For example, a curved hologram may be adapted to the external shape of the dashboard. Furthermore, the carrier of the hologram can be flat or curved.

If the hologram device has an anti-reflective surface according to another preferred embodiment of the invention, there may be advantages in preventing interfering reflections at the hologram device. The hologram device can, for example, have a protective layer, e.g. made of transparent plastic or glass, on the side facing the half space above the dashboard, the surface of the protective layer having e. g. an antireflective coating.

According to another preferred embodiment of the invention, the display apparatus is provided with a temperature sensor device for detecting the temperature of the hologram device, whereby the temperature sensor device is coupled with the control device. In this embodiment of the invention, the control device is designed to control the imaging device in dependency on the temperature detected by the hologram device. The imaging device is particularly preferably controlled in such a way that the light field is changed, in particular shifted and/or deformed, in dependency on the detected temperature in such a way that a temperature-dependent change in the virtual image of the display information is compensated. Advantageously, this results in distortion-free image reproduction independent of the temperature of the hologram device.

Advantageously, the temperature sensor device also enables detecting a shrinkage of a hologram layer of the hologram device, e.g. by a change in the polymer structure during the service life of the display apparatus. The shrinkage of the hologram layer affects the virtual image like a temperature change and can therefore be compensated by the control device.

Advantageously there are different possibilities to measure the temperature of the hologram device with the temperature sensor device. The temperature sensor device can, for example, have a thermocouple with which the temperature of the hologram device can be measured directly or the temperature in the immediate vicinity of the hologram device can be measured. Alternatively, the temperature sensor device may have an optical sensor which measures the temperature of the hologram device in dependency on at least one diffraction property of the hologram device.

In accordance with a further, particularly advantageous embodiment of the invention, the display apparatus is provided with a wavelength sensor device for detecting at least one emission wavelength of the imaging device, the wavelength sensor device being coupled to the control device. The control device is designed to control the imaging device in dependency on at least one detected emission wavelength of the imaging device. The control device can be used to control the imaging device in such a way that a wavelength-dependent change in the deflection direction of the hologram device and optionally of the intermediate screen is compensated and the virtual image is generated unchanged. The light field generated by the imaging device is shifted and/or deformed so that a predetermined white pixel appears at a predetermined position. In other words, with the control device, the pixels are arranged such that the considered pixel appears white. Advantageously, the wavelength sensor device allows to detect and compensate for a drift in the emission wavelength of the imaging device depending on the operating temperature and/or aging of the projector or laser backlight source via the effect of the control device.

When using the above intermediate screen in the form of a hologram, the wavelength sensing device preferably includes an optical sensor for sensing the diffraction direction of the intermediate screen. The diffraction direction of a part of the light field of the projector device can be detected e.g. with a line or area CCD chip. A change in the diffraction direction of the intermediate screen immediately provides information about the change in the emission wavelength of the projector device. Alternatively, the wavelength sensor device can be provided on the hologram device.

The combination of the wavelength sensor device, in particular with a line or area CCD chip, the imaging device and the control device, which are configured to detect at least one emission wavelength of the projector device and to correct a light field emitted by the imaging device, is advantageous not only for the display apparatus in accordance with the invention, but also for the control of projectors for other applications with the generation of virtual images, such as, for example, in gaming devices. The combination of the wavelength sensor device, the imaging device and the control device with the features disclosed in this description is therefore considered to be another independent subject of the invention even without the other features of the display apparatus.

According to a further advantageous embodiment of the invention, the display apparatus is provided with an image height adjustment device for correcting the virtual image in dependency on the head height of the user of the vehicle. The image height adjustment device is designed, for example, for adjusting the position and/or orientation of the hologram device in the light field of the imaging device and/or for adjusting the position and/or orientation of the imaging device relative to the hologram device. By actuating the image height adjustment device, e.g. with a manually operable actuator, the user can adjust the position of the virtual image according to his wishes.

In accordance with a second general aspect of the invention, the above objective is solved by a method of projecting display information in the field of view of a user of a vehicle, in which a light field carrying the display information is generated by an imaging device and deflected to the window shield of the vehicle by hologram device, so that a virtual image of the display information is generated in the field of view of the user. According to the invention, the light field is generated above the hologram device and directed to the hologram device from above, i.e. towards the ground. Preferably, the method is performed with the display apparatus according to the first general aspect of the invention.

In accordance with a preferred embodiment of the method according to the invention, the temperature of the hologram device is detected and the imaging device is controlled in dependency on the temperature detected. Advantageously, this allows a compensation of temperature-dependent shifts of the virtual image.

According to a further advantageous embodiment of the method according to the invention, at least one emission wavelength of the imaging device is detected and the imaging device is controlled in dependency on the detected emission wavelength. Advantageously, this compensates for shifts in the emission wavelength as a function of the operating temperature of the imaging device and improves the image quality of the virtual image.

According to a third general aspect of the invention, the above objective is solved by a vehicle provided with a display apparatus according to the first general aspect of the invention. Advantageously, the invention can be realized with different types of vehicles. Preferably, the vehicle comprises a motor vehicle or an aircraft (airplane) or a watercraft (ship).

Further details of the invention are described below with reference to the attached drawings, which show in:

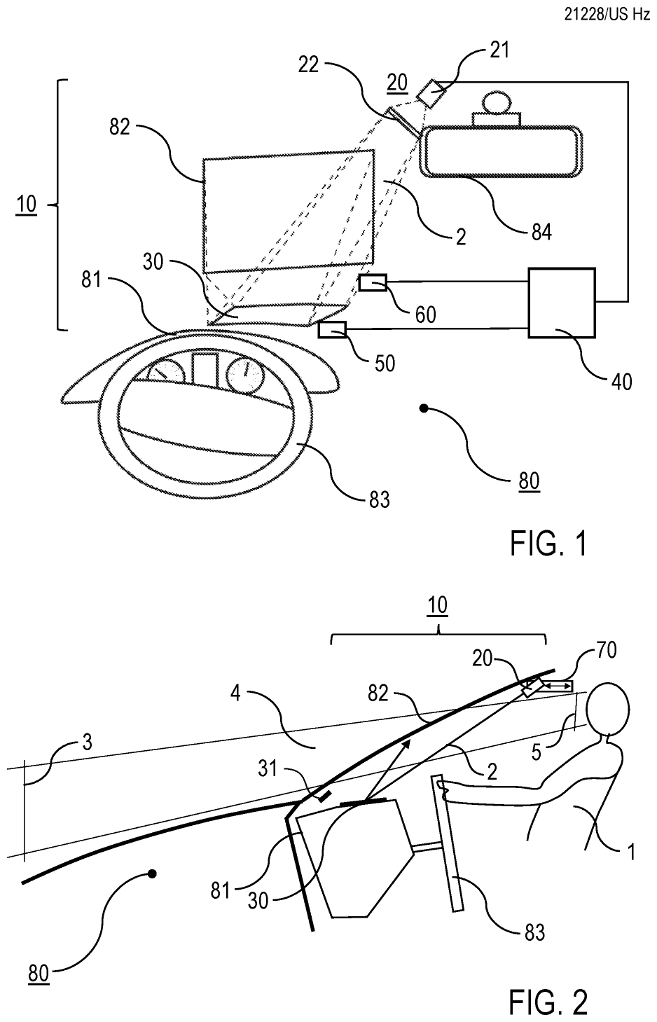

FIG. 1: a schematic perspective view of a preferred embodiment of the display apparatus in accordance with the invention from the vehicle driver's point of view;

FIG. 2: a schematic side view with an illustration of the beam path of a preferred embodiment of the inventive display apparatus; and

FIG. 3: a schematic cross-sectional view of a conventional display apparatus (prior art).

The invention is described in the following with exemplary reference to the application in a motor vehicle, wherein display information is presented to the driver of the motor vehicle with in his field of view, using the display apparatus. The invention is not limited to use in a motor vehicle, but can also be used in an aircraft or ship, for example. Features of the invention are described here in particular with reference to the arrangement of the hologram device and the imaging device and the beam path for generating the virtual image of the display information. Details of the fabrication of the hologram device and the generation of the hologram are not described, as these are known per se from prior art.

According to FIGS. 1 and 2, the preferred embodiment of the inventive display apparatus 10 comprises the imaging device 20 and the hologram device 30, which are arranged in the driver's compartment of a vehicle 80. The imaging device 20 is connected to a control device 40 which comprises, for example, a computer circuit and/or is integrated into the vehicle electronics. FIGS. 1 and 2 show schematically a part of the dashboard 81 and the front window 82 as well as the steering wheel 83 of the vehicle 80.

For the projection of display information in the field of view 2 of the driver 1, the light field 2, which carries the display information, is directed with the imaging device 20 from above onto the hologram device 30 and deflected with it to the front window 82 in the field of view 2 of the driver 1 so that the virtual image 3 of the display information is generated on the outside of the front window 82.

The imaging device 20 comprises, as shown schematically in FIG. 1, a laser projector 21, such as an RGB laser projector (e.g. of the type Pico-Projector), which contains laser sources, in particular laser diodes, with three different emission wavelengths in the red, green and blue spectral range. The laser sources are controlled by the control unit 40 in such a way that the light field 2 generated by the laser projector 21 represents the information to be displayed, e.g. a colour image and/or text content. The laser projector 21 is connected to the control device which provides the display information for the image to be displayed.

Furthermore, the imaging device 20 comprises an intermediate screen 22, e.g. in the form of a transmission hologram, the intermediate screen 22 directing the light field 2 in a directed manner from above onto the hologram device 30. The transmission hologram of the intermediate screen 22 is e.g. a broadband RGB hologram or a stack of several narrowband holograms designed for the respective emission wavelengths in the red, green and blue spectral range.

According to an alternative embodiment of the invention, the imaging device comprises a liquid crystal screen adapted to generate the light field 2 with a narrow band backlight source (not shown). In this embodiment, the projector 21 is replaced by the backlight source and the intermediate screen 22 is replaced by the liquid crystal screen. In this case, the liquid crystal screen receives the display information for the image to be displayed from the controller.

The hologram device 30 is arranged on the upper side of the dashboard 81, and it comprises a stacked structure, e.g. with a film carrier as carrier layer, a hologram layer containing the phase-volume hologram for deflecting the light field and for generating the virtual image 3, and a cover layer serving to protect and as antireflection coating of the hologram device. The individual layers can, for example, be made of transparent plastic and/or glass. The hologram layer is typically a plastic layer in which the hologram is inscribed.

The hologram layer of the hologram device 30 comprises a reflection hologram. This has the task of imaging the intermediate image of the imaging device 20 on the intermediate screen 22 on the windscreen in such a way that it is reflected exactly in the direction of the eyes of the driver 1. However, the light should only be emitted in the direction of the head in order to get by with as little light as possible. Therefore, the hologram geometry depends on the position of the imaging device, the head of the driver and the geometry of the windscreen. The position of the head of the driver 1 is presented by the “eye box” 5 (area where the eyes of the driver 1 with an average body height are located). Based on these parameters, the diffraction grating geometry of the reflection hologram is calculated using a procedure known per se. In order to generate the calculated grating structure in the hologram layer, a holographic film material is exposed with coherent and geometrically correspondingly shaped wave fronts with lasers of predetermined wavelengths. Exposure takes place in a manner known per se, preferably on a vibration-free optical table.

The size of the hologram device 30 determines the size of the virtual image 3 in the field of view of the driver 1 and is selected accordingly depending on the concrete application of the invention. The shape of the hologram device 30 can be convex or flat, whereby optionally a support is provided between the surface of the dashboard 81 and the hologram device 30 to adapt to the shape of the surface of the dashboard 81. In addition, as shown schematically in FIG. 2, the hologram device 30 can be provided with an opaque blocking screen 31 arranged between the hologram device 30 and the inside of the front window 82. The blocking screen 31 is configured to avoid unwanted direct reflections from the hologram device 30 to the front window 82.

The hologram of the hologram device 30 is configured in such a way that the virtual image 3 is generated on the outside of the front window 82 in the field of view 4 of the user 1. In order to avoid image errors due to variations in the temperature of the hologram device 30 and/or the operating temperature of the imaging device 20, the inventive display apparatus 10 is provided with a temperature sensor device 50 and/or a wavelength sensor device 60 (shown schematically in FIG. 1). The temperature sensor device 50, e.g. a thermocouple, measures the temperature of the hologram device 30. Based on an output signal of the temperature sensor device 50, the control device 40 controls the imaging device 20 in such a way that temperature-dependent displacements of the virtual image 3 are compensated.

The wavelength sensor device 60 comprises a CCD chip which is arranged downstream of the intermediate screen 22 and with which a part of the light field 2, such as a single pixel in the real intermediate image, is detected on the transmission hologram of the intermediate screen 22. With the control device 40, the light field 2 of the imaging device 20 is shifted in such a way that the considered pixel is detected with the CCD chip at a desired target position.

FIG. 2 further schematically illustrates an optional image height adjustment device 70 to which the imaging device 20 is coupled. With the image height adjustment device 70, the imaging device 20 can be shifted in such a way that the virtual image 3 is presented at the desired viewing height in the field of view 4 of the driver 1 (corresponding to his “eye box” 5). The adjustment of the image height is achieved, for example, by shifting the imaging device 20. The imaging device 20 may, for example, be displaceable on a rail on the rear-view mirror unit 84 and the image height adjustment device 70 may be designed for manual displacement of the imaging device 20 on the rail.

The features of the invention disclosed in the above description, drawings and claims may be relevant to the realisation of the invention in its various forms, either individually or in combination or subcombination.

1. Display apparatus configured to project display information in the field of view of a user of a vehicle with a dashboard and a front window, comprising:
an imaging device adapted to generate a light field carrying the display information,
a hologram device which, in an arrangement below the field of view of the user, is adapted for deflecting the light field to the front window and for generating a virtual image of the display information in the field of view of the user, and
a control device adapted to control the imaging device, wherein
the hologram device is configured for generating the virtual image when the imaging device is arranged above the hologram device and on a side of the hologram device facing the field of view of the user.

2. Display apparatus according to claim 1, wherein
the hologram device is configured for generating the virtual image with an arrangement of the imaging device above the dashboard of the vehicle.

3. Display apparatus according to claim 1, wherein
the hologram device is configured for generating the virtual image with an arrangement of the imaging device on a rear-view mirror unit of the vehicle.

4. Display apparatus according to claim 1, wherein
the imaging device includes a projector device with a projector arranged to generate the light field and with an intermediate screen configured to generate a real intermediate image of the light field emitted by the projector.

5. Display apparatus according to claim 4, wherein
the intermediate screen includes a hologram formed for directionally directing the light field from the projector device to the hologram device.

6. Display apparatus according to claim 1, wherein
the imaging device includes a liquid crystal screen adapted to generate the light field, said liquid crystal screen being provided with narrow band backlighting.

7. Display apparatus according to claim 1, wherein
the hologram device includes a reflective holographic optical element forming a tilted off-axis mirror.

8. Display apparatus according to claim 7, wherein
the hologram device includes at least one phase volume hologram representing the off-axis mirror.

9. Display apparatus according to claim 1, wherein
the hologram device includes a broadband RGB hologram or a stack of multiple narrowband holograms adapted for different wavelengths.

10. Display apparatus according to claim 1, wherein
the hologram device is configured for an exposed arrangement on a surface of the dashboard of the vehicle.

11. Display apparatus according to claim 10, wherein
the hologram device is configured for an arrangement directly on the dashboard of the vehicle.

12. Display apparatus according to claim 1, wherein
the hologram device has an anti-reflective surface.

13. Display apparatus according to claim 1, further comprising
a temperature sensor device which is adapted to detect the temperature of the hologram device and is coupled to the control device, the control device being adapted to control the imaging device in dependency on the detected temperature of the hologram device in such a way that the light field generated by the imaging device is at least one of shifted and deformed in dependency on the detected temperature and a temperature-dependent change in the virtual image of the display information is compensated.

14. Display apparatus according to claim 13, wherein
the temperature sensor device is adapted to detect the temperature in dependency on at least one diffraction feature of the hologram device.

15. Display apparatus according to claim 1, further comprising
a wavelength sensor device which is adapted for detecting at least one emission wavelength of the imaging device and is coupled with the control device, wherein
the control device is adapted to control the imaging device in dependency on the detected at least one emission wavelength of the imaging device in such a way that the light field generated by the imaging device is at least one of displaced and deformed in dependency on the detected at least one emission wavelength and a wavelength-dependent change in the diffraction direction of the hologram device is compensated.

16. Display apparatus according to claim 1, further comprising
an image height adjustment device which is provided for adapting the position of the virtual image to the head height of the user.

17. Display for projecting display information in the field of view of a user of a vehicle, comprising the steps of:
generating a light field carrying said display information with an imaging device, and
deflecting the light field to a front window of the vehicle in the field of view of the user and generating a virtual image of the display information on the side of the front window facing away from the user with a hologram device which is arranged in a region below the field of view of the user, wherein
the imaging device is disposed above the hologram device and on a side of the hologram device facing the field of view of the user.

18. Display according to claim 17, further comprising the steps of
recording the temperature of the hologram device, and
controlling the imaging device in dependency on the detected temperature of the hologram device.

19. Display according to claim 17, further comprising the steps of
detecting at least one emission wavelength of the imaging device, and
controlling the imaging device in dependency on the detected at least one emission wavelength of the projector device.

20. Display provided with a display apparatus according to claim 1.
